(19) United States
(12) Patent Application Publication
(10) Pub. No.: US 2025/0336342 A1
(43) Pub. Date: Oct. 30, 2025

(54) ELECTRONIC DEVICE AND METHOD FOR CHANGING DISPLAY STATE

(71) Applicant: Samsung Electronics Co., Ltd., Suwon-si (KR)

(72) Inventors: Dongheon SHIN, Suwon-si (KR); Kyoungmin PARK, Suwon-si (KR); Minwoo LEE, Suwon-si (KR); Juseok LEE, Suwon-si (KR); Donghwy KIM, Suwon-si (KR); Seungryeol KIM, Suwon-si (KR); Seoyoung LEE, Suwon-si (KR)

(21) Appl. No.: 19/258,547

(22) Filed: Jul. 2, 2025

Related U.S. Application Data
(63) Continuation of application No. PCT/KR2023/018383, filed on Nov. 15, 2023.

(30) Foreign Application Priority Data
Jan. 19, 2023 (KR) 10-2023-0008361
Jan. 31, 2023 (KR) 10-2023-0012553

(51) Int. Cl. G09G 3/32

(52) U.S. Cl. CPC G09G 3/32; G09G 2320/0646; G09G 2320/0666

(57) ABSTRACT

An electronic device may comprise: a processor. The electronic device may comprise a display driving circuit operatively coupled to the processor. The electronic device may comprise a display panel operatively coupled to the display driving circuit. The processor may be configured to cause the electronic device to: provide the display driving circuit with first data for a screen including a character having a first brightness level, thereby displaying the screen on the display panel; and based on an event indicating activation of a function for eye comfort, detected while the screen is being displayed based on the first data, provide the display driving circuit with second data for the screen including the character having a second brightness level higher than the first brightness level, thereby displaying the screen on the display panel.

### CROSS-REFERENCE TO RELATED APPLICATIONS

This application is a continuation of International Application No. PCT/KR2023/018383 designating the United States, filed on Nov. 15, 2023, in the Korean Intellectual Property Receiving Office and claiming priority to Korean Patent Application Nos. 10-2023-0008361, filed on Jan. 19, 2023, and 10-2023-0012553, filed on Jan. 31, 2023, in the Korean Intellectual Property Office, the disclosures of each of which are incorporated by reference herein in their entireties.

### BACKGROUND

### Field

The disclosure relates to an electronic device and a method for changing a display state.

### Description of Related Art

An electronic device may include a display panel. The electronic device may include a display driver circuitry operably (or operatively) coupled to a display panel. The display driver circuitry may display, on the display panel, an image obtained from a processor of the electronic device.

The above-described information may be provided as a related art for the purpose of helping to understand the present disclosure. No assertion or determination is raised as to whether any of the above-described information may be applied as a prior art related to the present disclosure.

### SUMMARY

electronic device is provided. The electronic device may comprise a processor. The electronic device may comprise display driver circuitry operably coupled with the processor. The electronic device may comprise a display panel operably coupled with the display driver circuitry. The processor may be configured to, by providing, to the display driver circuitry, first data for a screen including a character having a first brightness level, display, on the display panel, the screen. The processor may be configured to, while the screen is displayed based on the first data, identify an event indicating to activate a function for an eye comfort. The processor may be configured to, based on the event, display, on the display panel, the screen by providing, to the display driver circuitry, second data for the screen including the character having a second brightness level higher than the first brightness level.

A method is provided. The method may comprise, based on first data for a screen including a character having a first brightness level, displaying, on the display panel, the screen. The method may comprise, while the screen is displayed based on the first data, identifying an event indicating to activate a function for an eye comfort. The method may comprise, based on the event, displaying, on the display panel, the screen based on second data for the screen including the character having a second brightness level higher than the first brightness level.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an example electronic device according to various embodiments;

FIG. 2 is a diagram illustrating an example of first data and second data according to various embodiments;

FIG. 3 includes graphs illustrating a changed brightness level of a character in a screen according to various embodiments;

FIG. 4 is a diagram illustrating an example method of processing data for a function for an eye comfort according to various embodiments;

FIG. 5 includes graphs illustrating a change in a brightness level of an entire area of a screen executed according to data processing according to various embodiments;

FIG. 6 is a diagram illustrating an example of distortion appearing in a screen according to various embodiments;

FIG. 7 is a circuit diagram illustrating an example method of providing a second voltage, different from a first voltage, for a function for an eye comfort according to various embodiments;

FIG. 8 is a graph illustrating a brightness level of a screen displayed according to a voltage identified for a function for an eye comfort according to various embodiments;

FIG. 9 is a diagram illustrating an example of a user interface for a function for an eye comfort according to various embodiments;

FIG. 10 is a graph illustrating an intensity of a function for an eye comfort that adaptively changes according to time of day according to various embodiments;

FIG. 11 is a flowchart illustrating an example method of providing a function for an eye comfort according to an event according to various embodiments;

FIG. 12 is a flowchart illustrating an example method of executing a function for an eye comfort based on information on a usage state of a display according to various embodiments;

FIG. 13 is a graph illustrating an intensity of a function for an eye comport changed based on information on a usage state according to various embodiments;

FIG. 14 is a diagram illustrating an example method of changing a display state through a function for an eye comfort according to various embodiments;

FIG. 15 is a block diagram illustrating an example electronic device in a network environment according to various embodiments; and

FIG. 16 is a block diagram illustrating an example configuration of a display module according to various embodiments.

### DETAILED DESCRIPTION

An electronic device may execute a function for an eye comfort. As a non-limiting example, a color temperature of a screen displayed on a display panel based on the execution may be lower than a color temperature of the screen displayed on the display panel without the execution (or bypassing the execution) for an eye comfort. As a non-limiting example, a color gamut of the screen displayed based on the execution may be lower than a color gamut of the screen displayed on the display panel without the execution (or bypassing the execution). As a non-limiting example, a brightness level of the screen displayed based on the execution may be higher than a brightness level of the screen displayed on the display panel without the execution (or bypassing the execution), for an eye comfort. For example, the function may be referred to as an eye comfort setting, an eye comfort shield, an eye comfort mode, or a night shift setting.

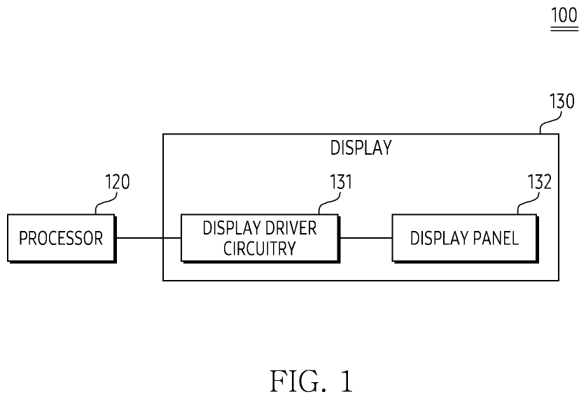

For example, the electronic device may include components for executing the function. The components may be illustrated with reference to FIG. 1.

FIG. 1 is a block diagram illustrating an example configuration of an example electronic device according to various embodiments.

Referring to FIG. 1, an electronic device 100 may include a processor (e.g., including processing circuitry) 120 and a display 130.

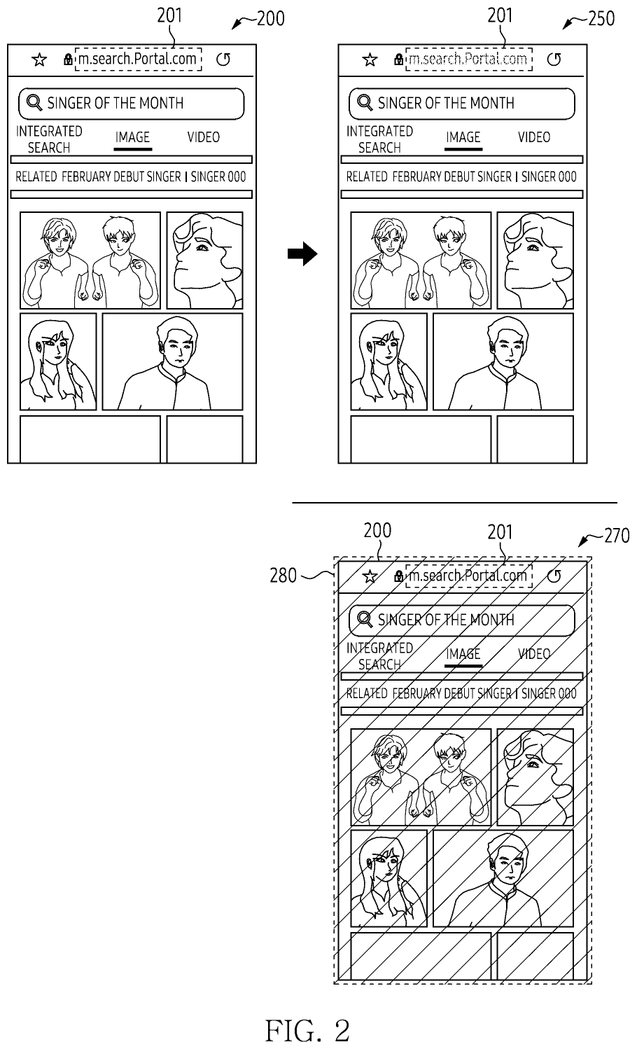

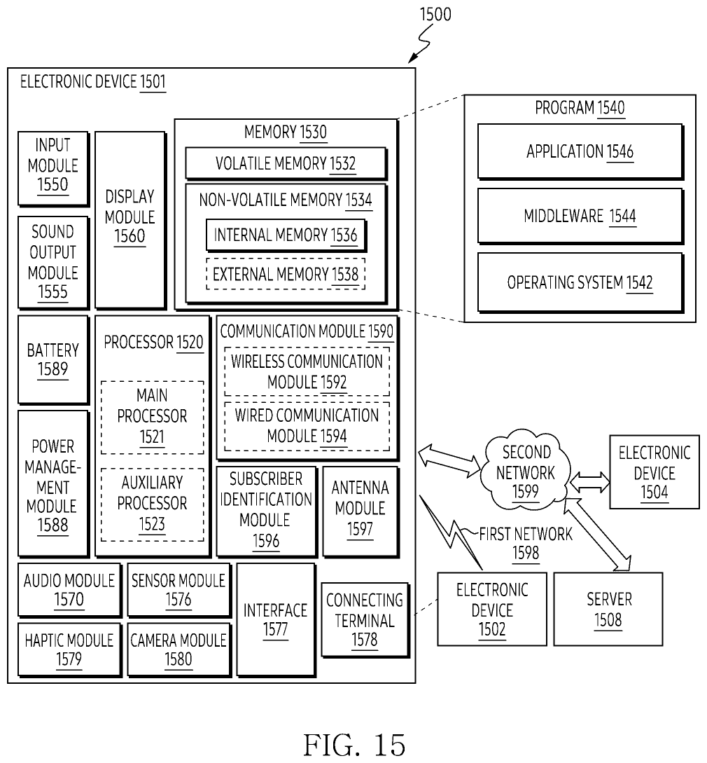

For example, the processor 120 may be used for at least a portion of operations illustrated and described with reference to FIGS. 2 to 14. For example, the processor 120 may be operably coupled with the display 130 and/or display driver circuitry 131 within the display 130. For example, the processor 120 may include at least a portion of the processor 1520 of FIG. 15.

For example, the display 130 may include display driver circuitry 131 and a display panel 132.

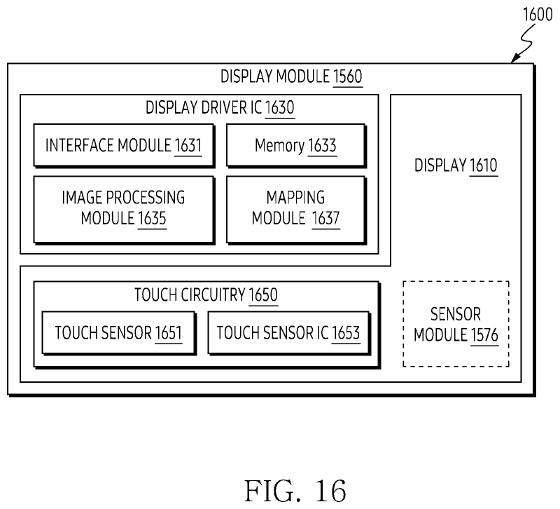

For example, the display driver circuitry 131 may be used for at least a portion of operations illustrated and described with reference to FIGS. 2 to 14. For example, the display driver circuitry 131 may be operably coupled with the processor 120. For example, the display driver circuitry 131 may be operably coupled with the display panel 132. For example, the display driver circuitry 131 may include at least a portion of the display driver IC 1630 of FIG. 16.

For example, the display panel 132 may be used for at least a portion of operations illustrated and described with reference to FIGS. 2 to 14. For example, the display panel 132 may be operably coupled with the display driver circuitry 131. For example, the display panel 132 may include at least a portion of the display 1610 of FIG. 16.

For example, the processor 120 may generate, obtain, render, or configure a screen to be displayed on the display panel 132. For example, the processor 120 may identify a character within the screen to be displayed on the display panel 132, for an eye comfort. For example, the character may be an entity defined for communication. For example, the character may include a letter. For example, the character may include a symbol, a mark, and/or a sign. For example, the character may include a number. For example, the character may include an icon, such as an emoticon or an emoji graphical object. However, the disclosure is not limited thereto.

For example, the character may be expressed in a binary code such as Unicode, American standard code for information interchange (ASCII), or American national standard institute (ANSI). For example, the character may be included in a text object in layout data for the screen. For example, the text object may include TextView, UILabel, or Label. For example, the text object may be different from an image object such as Image View, UIImage (or UIImage View), or CImage. For example, the processor 120 may identify the text object from the layout data and identify the character included in the text object.

For example, the processor 120 may change a brightness level of the character, for eye comfort. For example, the processor 120 may change the brightness level from a first brightness level to a second brightness level higher than the first brightness level. For example, a contrast ratio of the character displayed on the display panel 132 based on the second brightness level may be lower than a contrast ratio of the character displayed on the display panel 132 based on the first brightness level. A contrast ratio of the character may indicate a difference between the highest brightness level and the lowest brightness level within an area including the character and a background portion at which the character is positioned. As a non-limiting example, the contrast ratio of the character displayed on the display panel 132 based on the second brightness level may be about 10:1, like a contrast ratio of a character in a newspaper or an electronic book.

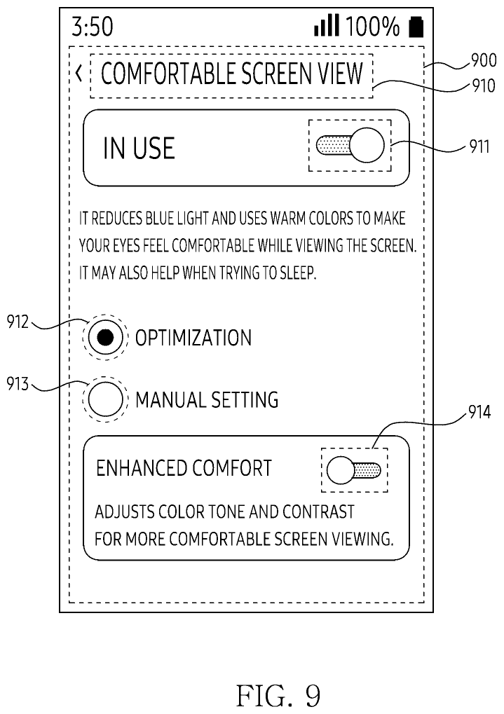

For example, the processor 120 may obtain first data for a screen including the character having the first brightness level while the function for an eye comfort is disabled. For example, the processor 120 may obtain second data for a screen including the character having the second brightness level based on an event indicating to enable the function. The event will be illustrated in greater detail below with reference to FIG. 9. The first data and the second data may be illustrated in greater detail with reference to FIG. 2.

FIG. 2 is a diagram illustrating examples of the first data and the second data according to various embodiments.

Referring to FIG. 2, the processor 120 may obtain first data 200 while the function is disabled. For example, in the first data 200 obtained based on the layout data, characters within an area 201 may be included in a text object, unlike other characters outside the area 201. For example, each of the characters within the area 201 may have the first brightness level. For example, the processor 120 may display, on display panel 132, the screen, by providing the display driver circuitry 131 with the first data 200 for the screen including the characters each having the first brightness level.

For example, the processor 120 may identify the event indicating to enable the function for an eye comfort, while the screen is displayed based on the first data 200.

For example, the processor 120 may obtain second data 250, which is partially different from the first data 200, based on the event. For example, the processor 120 may display, on the display panel 132, the screen, by providing the display driver circuitry 131 with the second data 250 for the screen including the characters each having the second brightness level.

For example, in response to the event, the processor 120 may identify, from the layout data, the characters within the area 201 included in the text object. For example, the processor 120 may change a brightness level of each of the characters within the area 201 from the first brightness level to the second brightness level. For example, since the characters within the area 201 are included in the text object, unlike the other characters outside the area 201, a brightness level of each of the characters within the area 201 may be changed, unlike a brightness level of each of the other characters outside area 201, which is maintained independently of the event.

For example, a grayscale of each of the characters (e.g., the characters within the area 201 in the second data 250) each having the second brightness level may be higher than a grayscale of each of the characters (e.g., the characters within the area 201 in the first data 200) each having the first brightness level. As a non-limiting example, when the first brightness level is 1 (cd/m²) (wherein ‘cd’ is candela and ‘m’ is meter), the second brightness level may be 100 (cd/m²).

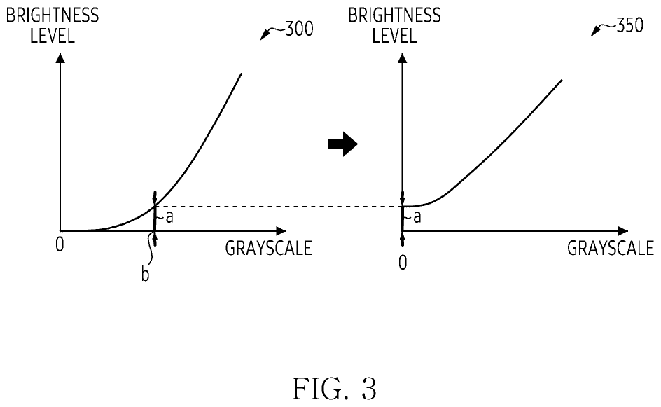

The change from the first brightness level to the second brightness level may be illustrated in greater detail below with reference to FIG. 3.

FIG. 3 includes graphs illustrating a changed brightness level of a character in a screen according to various embodiments.

Referring to FIG. 3, a graph 300 represents a relationship between a grayscale and a brightness level of each of the characters within an area 201 in first data (e.g., the first data 200 of FIG. 2), and a graph 350 represents a relationship between a grayscale and a brightness level of each of the characters within the area 201 in second data (e.g., the second data 250 of FIG. 2). For example, when a grayscale of each of the characters within the area 201 is 0, a difference between the first brightness level of each of the characters within the area 201 in the first data 200 and the second brightness level of each of the characters within the area 201 in the second data 250 may be a. For example, the second brightness level of each of the characters within the area 201 in the second data 250 may correspond to a grayscale b in the first data 200, as indicated by the graph 300. However, the disclosure is not limited thereto.

Referring back to FIG. 2, the second brightness level may be different from a brightness level of each of the characters within the area 201 in third data 270, which is obtained by changing a color temperature of the first data 200 for an eye comfort. It should be noted that a layer 280 is only illustrated in FIG. 2 to visually indicate that the third data 270 is obtained by changing the color temperature of the first data 200. For example, the screen displayed on the display panel 132 based on the second data 250 may provide an enhanced eye comfort service compared to the screen displayed on the display panel 132 based on the third data 270.

According to an embodiment, the processor 120 may identify the first brightness level of each of the characters within the area 201 included in the text object, in response to the event. For example, the processor 120 may obtain the second data 250 based on the first brightness level being lower than a reference brightness level, and may bypass or refrain from obtaining the second data 250 based on the first brightness level being higher than or equal to the reference brightness level. For example, since the first brightness level being higher than or equal to the reference brightness level may indicate that a contrast ratio of each of the characters within the area 201 corresponds to a contrast ratio of characters in the newspaper, the processor 120 may refrain from obtaining the second data 250 even in a case that the event is identified when the first brightness level is higher than or equal to the reference brightness level. As a non-limiting example, in response to the event, the processor 120 may obtain the second data 250 or may refrain from obtaining the second data 250, using a code represented as in Table 1 (e.g., 32 gray) below.

```
TABLE 1
% Input Variable Initialize
Input_Font_R = 0;
Input_Font_G = 255;
Input_Font_B = 0;
Input_Co = 0;
Input_Cg = 0;
Input_Y = 0;
Pro_Y = 0;
Output_Font_R = 0;
Output_Font_G = 0;
Output_Font_B = 0;
15 The brightness and color of Font are composed of Red, Green, and Blue components
% Control Parameter (Threshold)
Output_Font_Y_Gain = 32;
% Convert RGB to YCoCg
% This is to separate the brightness(Y) and color components from the red, green, and blue
components of Font, and to change only the brightness(Y) components while maintaining the
color.
Input_Co = ( 0.5*Input_Font_R) − (0.5*Input_Font_B);
Input_Cg = ( −0.25*Input_Font_R)+( 0.5*Input_Font_G) + ( −0.25*Input_Font_B);
Input_Y = (0.25*Input_Font_R) + (0.5*Input_Font_G) + (0.25*Input_Font_B);
% Compare input Y of Font with threshold
% Determine the output Y according to the brightness Y component of Font.
% Apply algorithm only to values less than (Threshold + 16) among input Y values
if (Input_Y < (Output_Font_Y_Gain+16))
  Pro_Y = round( Output_Font_Y_Gain + (Input_Y /4) ,0);
else
  Pro_Y = Input_Y;
end
% Restore to Red, Green, and Blue components after applying the algorithm.
Output_Font_R = Pro_Y − Input_Cg + Input_Co;
Output_Font_G = Pro_Y + Input_Cg;
Output_Font_B = Pro_Y − Input_Cg − Input_Co;
```

For example, the processor 120 may obtain the second data 250 by changing the luminance (Y), orange chrominance (Co), and green chrominance (Cg) of each of the characters within the area 201 when the first brightness level, Input_Y, is lower than the reference brightness level, Output_Font_Y_Gain+16, as shown in Table 1, and obtain the first data 200 otherwise. However, the disclosure is not limited thereto.

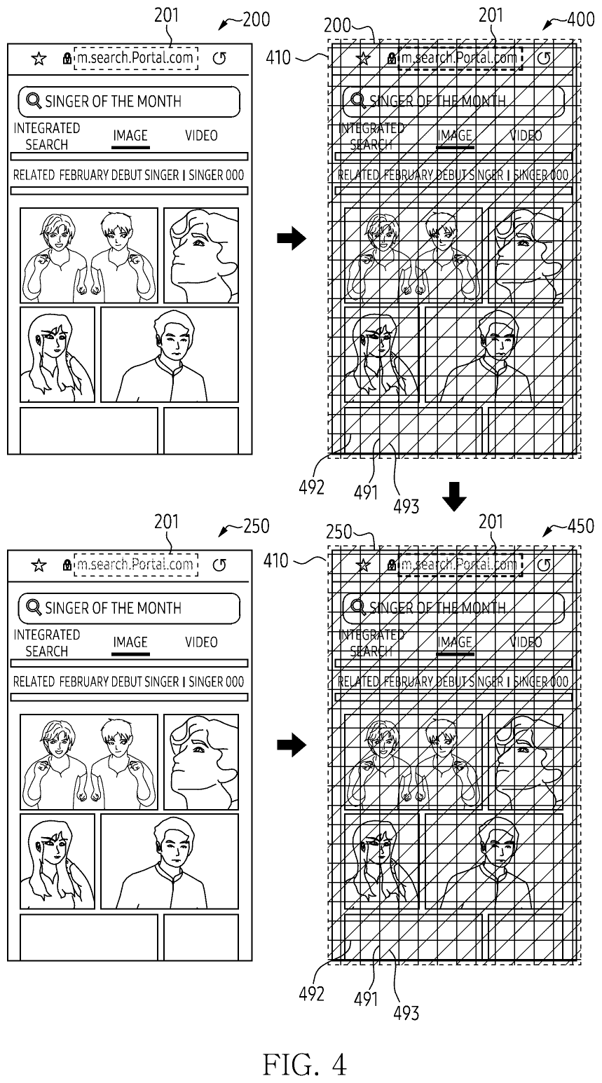

Referring back to FIG. 1, the display driver circuitry 131 may process data provided from the processor 120 and display the screen on the display panel 132 based on the processed data, for an eye comfort. For example, the display driver circuitry 131 may process the first data or the second data from the processor 120, based on the event, for an eye comfort. For example, the processing of the display driver circuitry 131 may be executed based on a control signal (or control command) provided to the display driver circuitry 131 from the processor 120. For example, the display driver circuitry 131 may obtain, by processing the first data (or the second data) to change a brightness level of an entire area of the screen from a third brightness level to a fourth brightness level based on the event (or the control signal), third data (or fourth data) converted from the first data (or the second data), and display the screen on the display panel 132 based on the third data (the fourth data). For example, the third data (or the fourth data) may be obtained to provide a contrast ratio lower than a contrast ratio of a screen displayed based on the first data (or the second data). The third data and the fourth data may be illustrated in greater detail below with reference to FIG. 4.

FIG. 4 is a diagram illustrating an example method of processing data for a function for an eye comfort according to various embodiments.

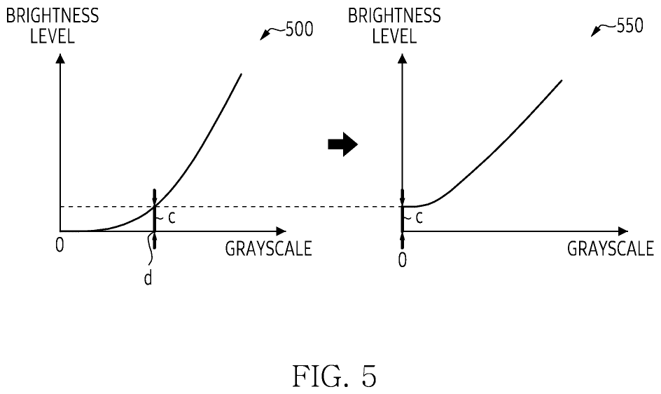

Referring to FIG. 4, the display driver circuitry 131 may obtain third data 400 by processing the first data 200 obtained from the processor 120 to change the brightness level of the entire area of the screen from the third brightness level to the fourth brightness level based on the event. Changing the brightness level of the entire area of the screen may indicate changing not only the brightness level of the character but also the brightness level of each visual object within the screen. However, the disclosure is not limited thereto. For example, the display driver circuitry 131 may obtain fourth data 450 by processing the second data 250 obtained from the processor 120 to change the brightness level of the entire area of the screen from the third brightness level to the fourth brightness level based on the event. The change from the third brightness level to the fourth brightness level may be illustrated in greater detail below with reference to FIG. 5.

FIG. 5 includes graphs illustrating a change in a brightness level of an entire area of a screen executed according to data processing according to various embodiments.

Referring to FIG. 5, a graph 500 represents a relationship between a grayscale and a brightness level of the screen displayed based on the first data 200 (or the second data 250), and a graph 550 represents a relationship between a grayscale and a brightness level of the screen displayed based on the third data 400 (or the fourth data 450). For example, a difference between a brightness level of a position where the grayscale is 0 within the screen displayed based on the first data 200 (or the second data 250) and a brightness level of a position where the grayscale is 0 within the screen displayed based on the third data 400 (or the fourth data 450) may be c. For example, the brightness level of a position where the grayscale is 0 within the screen displayed based on the third data 400 (or the fourth data 450) may correspond to a brightness level of a position where the grayscale is d within the screen displayed based on the first data 200 (or the second data 250). However, the disclosure is not limited thereto.

Referring back to FIG. 4, the display driver circuitry 131 may obtain the third data 400 (or the fourth data 450) by processing the first data 200 (or the second data 250) to further change a color gamut of the screen, for an eye comfort. For example, the display driver circuitry 131 may obtain the third data 400 (or the fourth data 450) by processing the first data 200 (or the second data 250) to further change color temperature of the screen, for an eye comfort. For example, a layer 410 may indicate that a change 491 in brightness level of the entire area of the screen, a change 492 in color gamut, and/or a change 493 in color temperature are executed. It should be noted that the layer 410 is only illustrated in FIG. 4 to visually indicate that the third data 400 (or the fourth data 450) is obtained by changing the brightness level, color gamut, and color temperature of the first data 200 (or the second data 250). For example, the screen displayed on the display panel 132 based on the third data 400 (or the fourth data 450) may provide an enhanced eye comfort service compared to the screen displayed on the display panel 132 based on the first data 200 (or the second data 250).

FIG. 4 illustrates an example in which the display driver circuitry 131 obtains the third data 400 or the fourth data 450 based on the event, but obtaining the third data 400 or the fourth data 450 may also be executed by the processor 120 based on the event. In this case, the processor 120 may display the screen on the display panel 132, by providing the third data 400 or the fourth data 450 to the display driver circuitry 131.

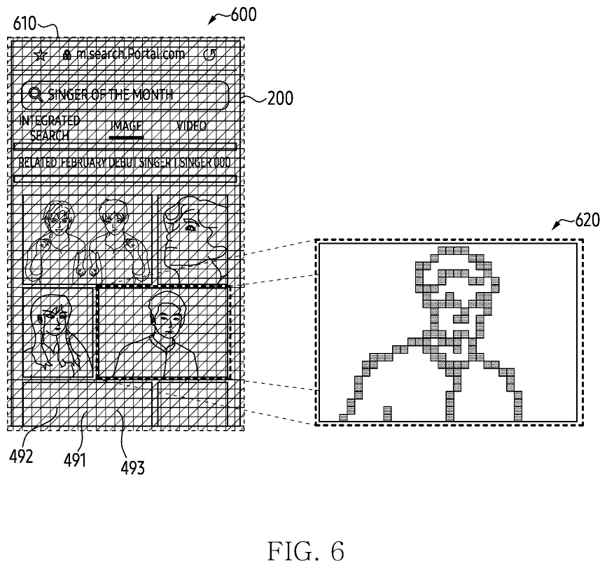

Referring back to FIG. 1, the display driver circuitry 131 may adjust a voltage provided to the display panel 132, for an eye comfort. A contrast ratio of a screen displayed on the display panel 132 based on the adjustment of the voltage may be lower than a contrast ratio of the screen displayed on the display panel 132 without the adjustment of the voltage. For example, the display panel 132 may include light-emitting diodes (e.g., organic light emitting diode (OLED)) and driving transistors for driving each of the light-emitting diodes. For example, each of the driving transistors may be used to provide current to each of the light-emitting diodes. For example, the display driver circuitry 131 may display, on the display panel 132, the screen, based on providing, a gate electrode of at least a portion of the driving transistors, another voltage distinct from a voltage corresponding to a brightness level of data (e.g., the first data, the second data, the third data, or the fourth data) for the screen. For example, since a conversion from the first data to the third data (or a conversion from the second data to the fourth data) is executed by digital processing, when a difference between a brightness level (e.g., the third brightness level) of the first data (or the second data) and a brightness level (e.g., the fourth brightness level) of the third data (or the fourth data) is relatively large, distortion (e.g., aliasing) may appear in the screen displayed based on the third data (or the fourth data). For example, in order to reduce the distortion, the display driver circuitry 131 may provide, to the gate electrode of the at least a portion of the driving transistors, the other voltage. The distortion may be illustrated in greater detail below with reference to FIG. 6.

FIG. 6 is a diagram illustrating an example of distortion appearing in a screen according to various embodiments.

Referring to FIG. 6, third data 600 may be converted from first data 200, by processing the first data 200 to change the brightness level of the entire area of the screen from the third brightness level to the fourth brightness level. A layer 610 illustrated in FIG. 6 for the third data 600 may indicate that a change 491 in brightness level of an entire area of a screen, a change 492 in color gamut, and/or a change 493 in color temperature are executed when converting from the first data 200 to the third data 600. It should be noted that the layer 610 of FIG. 6 is illustrated in FIG. 6 to visually indicate that the third data 600 is obtained by changing the brightness level, the color gamut, and the color temperature of the first data 200. A density of lines in the layer 610, which is higher than a density of lines in the layer 410 of FIG. 4, may indicate that a difference between the first data 200 and the third data 600 is greater than a difference between the first data 200 and third data (e.g., the third data 400 of FIG. 4).

For example, since the conversion from the first data 200 to the third data 600 is a digital processing, the amount of distortion 620 (or decrease in quality of a screen) of the screen caused by the conversion from the first data 200 to the third data 600 when a difference value between the third brightness level and the fourth brightness level is higher than a reference value may be greater than the amount of distortion when the difference value is lower than or equal to the reference value. For example, independently of whether the difference value is higher than the reference value, a distortion 620 when the fourth brightness level (and/or the third brightness level) is lower than a threshold brightness level may be more visible than a distortion 620 when the fourth brightness level (and/or the third brightness level) is higher than or equal to the threshold brightness level.

FIG. 6 illustrates the distortion 620 caused by the conversion from the first data 200 to the third data 600, but a distortion, such as the distortion 620, may also be caused by the conversion from the second data to the fourth data.

Referring back to FIG. 1, in order to reduce the distortion (e.g., the distortion 620) or reduce the visibility of the distortion, the display driver circuitry 131 may obtain fifth data (or sixth data) converted from the first data (or the second data), by processing the first data (or the second data) to change the third brightness level to a fifth brightness level between the third brightness level and the fourth brightness level. For example, the display driver circuitry 131 may display, on the display panel 132, the screen, based on providing, to a gate electrode of the at least a portion of the driving transistors, a second voltage different from a first voltage corresponding to the fifth brightness level. For example, the second voltage may correspond to the fourth brightness level. For example, obtaining the fifth data (or the sixth data) and/or providing the second voltage may be executed based on a control signal (or control command) provided from the processor 120. However, the disclosure is not limited thereto.

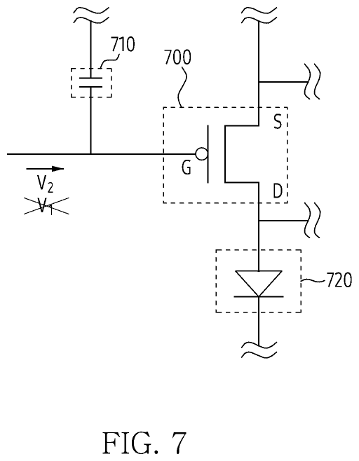

For example, unlike converting the first data (or the second data) to the third data (or the fourth data), since providing the second voltage is analog processing, providing the second voltage may reduce the distortion. Providing the second voltage may be illustrated in greater detail below with reference to FIG. 7.

FIG. 7 is a circuit diagram illustrating an example method of providing a second voltage, different from a first voltage, for a function for an eye comfort according to various embodiments.

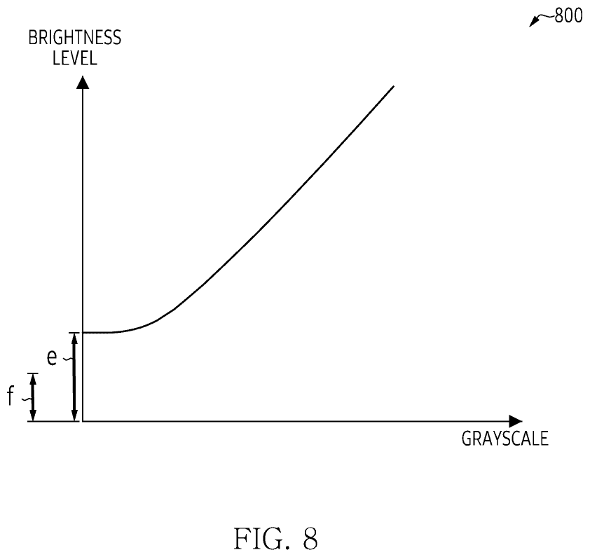

Referring to FIG. 7, the display driver circuitry 131 may identify changing a brightness level of an entire area of a screen to be displayed on the display panel 132 from the third brightness level to the fourth brightness level, for an eye comfort. For example, the identification may be executed based on a control signal (or control command) provided to the display driver circuitry 131 from the processor 120. For example, the display driver circuitry 131 may identify a fifth brightness level lower than the fourth brightness level (or a fifth brightness level between the third brightness level and the fourth brightness level) based on identifying that the difference value between the third brightness level and the fourth brightness level is higher than the reference value, or that the fourth brightness level (and/or the third brightness level) is lower than the threshold brightness level, and may obtain, by processing the first data (or the second data) to change the third brightness level to the fifth brightness level, fifth data (or sixth data) changed from the first data. For example, the display driver circuitry 131 may display, on the display panel 132, the screen, based on providing, to a gate electrode of at least a portion of the driving transistors, a second voltage, corresponding to the fourth brightness level, different from the first voltage corresponding to the fifth data (or the sixth data) (or corresponding to the fifth brightness level). For example, the display driver circuitry 131 may display, on the display panel 132, the screen, based on emitting a light-emitting diode 720 connected to a drain electrode D of a driving transistor 700 (T1) by providing a second voltage 2, corresponding to the fourth brightness level, different from the first voltage 1 corresponding to the fifth brightness level to a gate electrode G of the driving transistor 700 connected to a capacitor 710 for storing data. A source electrode S of the driving transistor 700 may be connected to another transistor. A brightness level that changes according to providing the second voltage 2 may be illustrated in greater detail below with reference to FIG. 8.

FIG. 8 is a graph illustrating a brightness level of a screen displayed according to a voltage identified for a function for an eye comfort according to various embodiments.

Referring to FIG. 8, a graph 800 represents a relationship between a grayscale and a brightness level of a screen displayed based on providing a second voltage V₂. For example, a brightness level of a position where the grayscale is 0 within the screen may correspond to a value c. For example, the value e may be greater than a value f corresponding to a brightness level of the position of the screen displayed on the display panel 132 based on data (e.g., the fifth data or the sixth data). For example, the electronic device 100 may provide an enhanced eye comfort service in a state of maintaining a quality of the screen, by providing the second voltage V₂.

Referring back to FIG. 1, in response to the difference value being lower than or equal to the reference value, or the fourth brightness level being higher than or equal to the threshold brightness level, the display driver circuitry 131 may display, on the display panel 132, the screen, based on bypassing providing the second voltage to a gate electrode of each of the driving transistors. For example, the display driver circuitry 131 may convert the first data (or the second data) into the third data (or the fourth data) in response to the difference value being lower than or equal to the reference value, or the fourth brightness level being higher than or equal to the threshold brightness level, and display the screen on the display panel 132 by providing a voltage corresponding to the third data (or the fourth data) to each of the driving transistors.

A function for an eye comfort executed through the above-illustrated operations may be set through a user interface. The user interface may be illustrated in greater detail below with reference to FIG. 9.

FIG. 9 is a diagram illustrating an example of a user interface for a function for an eye comfort according to various embodiments.

Referring to FIG. 9, a user interface 900 may be displayed on the display panel 132, in response to a user input indicating to select a menu 910 for an eye comfort from among menus for a global setting of the electronic device 100. For example, the user interface 900 may include an executable object 911 capable of receiving a user input indicating to enable a function for an eye comfort or a user input indicating to disable the function. For example, the executable object 911 illustrated in FIG. 9 may indicate the function being enabled.

When the executable object 911 indicates enabling the function, an item 912, an item 913, and an item 914 may be enabled to receive a user input, within the user interface 900.

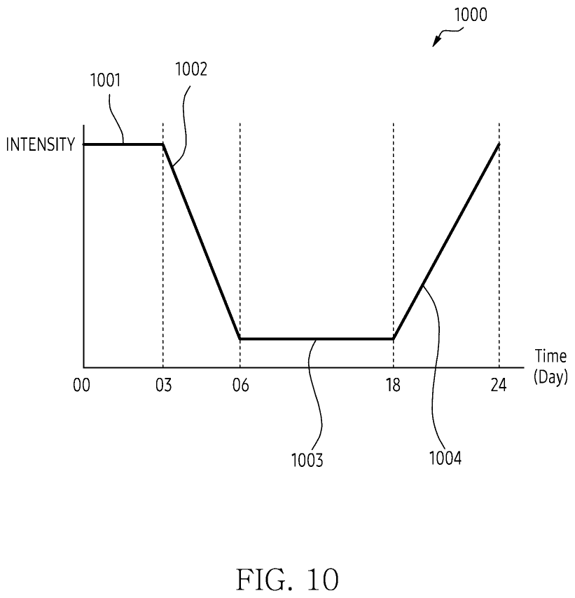

For example, the item 912 may be used to adaptively change an intensity at which the function is provided according to time of day, based on the identification of the electronic device 100. The intensity may indicate a degree to which a brightness level of a character is changed for an eye comfort, a degree to which color temperature of a screen is changed for an eye comfort, a degree to which a brightness level of an entire area of a screen is changed for an eye comfort, and/or a degree to which a color gamut of a screen is changed for an eye comfort. The use of the item 912 may be illustrated in greater detail below with reference to FIG. 10.

FIG. 10 is a graph illustrating an intensity of a function for an eye comfort that adaptively changes according to time of day according to various embodiments.

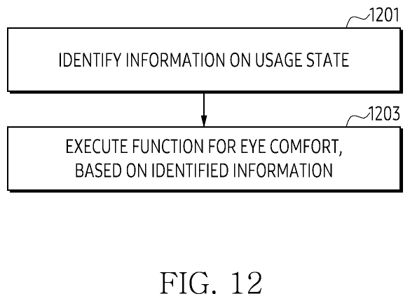

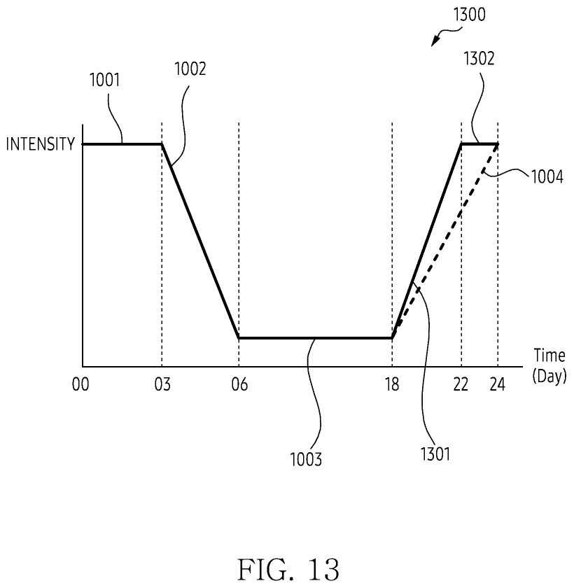

Referring to FIG. 10, a graph 1000 may represent the intensity that adaptively changes according to time of day. For example, at a time of day between 0 o'clock and 3 o'clock, the processor 120 may provide the function at a maximum intensity using the display driver circuitry 131 and the display panel 132, as indicated by the line 1001. For example, at a time of day between 3 o'clock and 6 o'clock, the processor 120 may provide the function at an intensity that gradually decreases over time, using the display driver circuitry 131 and the display panel 132, as indicated by the line 1002. For example, at a time of day between 6 o'clock and 18 o'clock, the processor 120 may provide the function at a minimum intensity using the display driver circuitry 131 and the display panel 132, as indicated by the line 1003. The minimum intensity may be 0. For example, providing the function at the minimum intensity may indicate that the function is disabled. However, the disclosure is not limited thereto. For example, at a time of day between 6 o'clock and 24 o'clock (or 0 o'clock), the processor 120 may provide the function at an intensity that gradually increases over time, as indicated by the line 1004. The time of days illustrated in the graph 1000 may be changed by the identification of the processor 120 (and/or the display driver circuitry 131) according to a usage state of the display 130. The change will be illustrated in greater detail below with reference to FIGS. 12 and 13.

Referring back to FIG. 9, the item 913 may be used to execute the function, at a time of day identified by user selection, with an intensity identified by user selection. For example, the use of the item 913 may be restricted when the item 912 is selected by a user input. For another example, the use of the item 912 may be restricted when the item 913 is selected by an input (e.g., a user input).

For example, the item 914 may be used to execute the operations illustrated and described with reference to FIGS. 2 and 3, the operations illustrated and described with reference to FIGS. 4 and 5, and/or the operations illustrated and described with reference to FIGS. 7 and 8. For example, when the item 914 indicates that it is enabled based on a user input, the electronic device 100 may execute the operations illustrated and described with reference to FIGS. 2 and 3, the operations illustrated and described with reference to FIGS. 4 and 5, and/or the operations illustrated and described with reference to FIGS. 7 and 8. For another example, when the item 914 indicates that it is disabled based on a user input, the electronic device 100 may bypass or refrain from executing the operations illustrated and described with reference to FIGS. 2 and 3, the operations illustrated and described with reference to FIGS. 4 and 5, and the operations illustrated and described with reference to FIGS. 7 and 8. For example, when the executable object 911 indicates that the function is enabled, and the item 914 indicates that it is disabled based on user input, the electronic device 100 may change color temperature of a screen for an eye comfort, and bypass or refrain from executing the operations illustrated and described with reference to FIGS. 2 and 3, the operations illustrated and described with reference to FIGS. 4 and 5, and the operations illustrated and described with reference to FIGS. 7 and 8. However, the disclosure is not limited thereto.

For example, the event illustrated in the description of FIG. 1 may be identified based at least in part on a state of the user interface 900.

For example, when a user input indicating to select the item 912 is received via the user interface 900, the processor 120 may identify the event through a setting represented by the graph 1000 or a graph 1300 (e.g., the graph 1300 of FIG. 13) to be illustrated and described below. As a non-limiting example, as represented by the graph 1000 of FIG. 10, the processor 120 may identify the event indicating to enable the function (or an event increasing an intensity of applying the function) by identifying that the local time is 18 o'clock in a state indicating that the item 914 is enabled. For example, as represented by the graph 1000 of FIG. 10, the processor 120 may identify disabling the function by identifying that the local time is 6 o'clock in a state indicating that the item 914 is enabled.

For another example, when a user input indicating to enable the item 914 is received via the user interface 900 in a state that the item 913 is selected, the processor 120 may identify the event by identifying the user input.

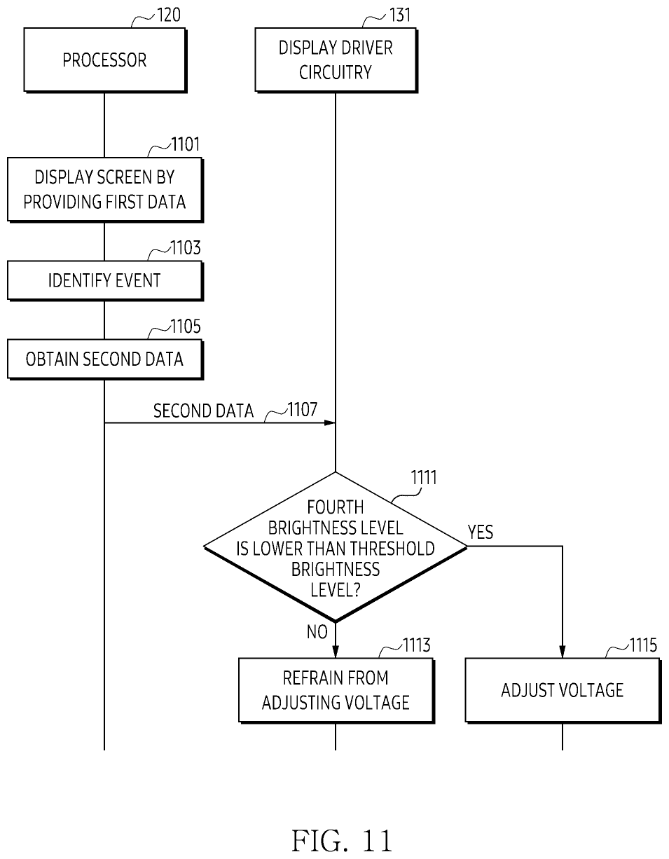

The operations illustrated and described with reference to FIGS. 2 and 3, the operations illustrated and described with reference to FIGS. 4 and 5, and the operations illustrated and described with reference to FIGS. 7 and 8 may be combined for the function. The combination may be illustrated and described with reference to FIG. 11.

FIG. 11 is a signal flow diagram illustrating an example method of providing a function for an eye comfort according to an event according to various embodiments.

Referring to FIG. 11, in operation 1101, the processor 120 may provide, to the display driver circuitry 131, first data for a screen including a character having a first brightness level to display the screen on the display panel 132.

In operation 1103, the processor 120 may identify an event indicating to enable a function for an eye comfort while the screen is displayed according to the first data. For example, the processor 120 may execute operation 1105 in response to the identification.

In operation 1105, the processor 120 may obtain second data that is partially different from the first data. For example, the processor 120 may execute at least a portion of the operations illustrated and described with reference to FIGS. 2 and 3. For example, the second data may be obtained to set a brightness level of the character differently from the first data. For example, the second data may be data for the screen including the character having a second brightness level higher than the first brightness level. For example, the character may be a character included in a text object identified from layout data for the screen. For example, the character may have the second brightness level changed from the first brightness level in the second data, unlike another character included in an image object identified from the layout data whose brightness level is maintained independently of the event.

In operation 1107, the processor 120 may provide the second data to the display driver circuitry 131. The display driver circuitry 131 may obtain the second data from the processor 120.

In operation 1111, the display driver circuitry 131 may identify whether a fourth brightness level is lower than a threshold brightness level, before processing the second data to change the brightness level of the entire area of the screen from the third brightness level to the fourth brightness level. For example, the display driver circuitry 131 may execute operation 1115 in response to the fourth brightness level being lower than the threshold brightness level, and execute operation 1113 in response to the fourth brightness level being higher than or equal to the threshold brightness level.

According to an embodiment, a relationship between the fourth brightness level and the threshold brightness level may be identified by the processor 120. For example, the processor 120 may provide, to the display driver circuitry 131, a control signal indicating to execute operation 1115 in response to the fourth brightness level being lower than the threshold brightness level, and provide, to the display driver circuitry 131, a control signal indicating to execute operation 1113 in response to the fourth brightness level being higher than or equal to the threshold brightness level.

According to an embodiment, operation 1111 may be replaced with another operation. For example, the display driver circuitry 131 may identify whether an illuminance around the electronic device 100 is lower than a reference illuminance, and execute operation 1115 in response to the illuminance (illuminance around the electronic device 100) being lower than the reference illuminance, and may execute operation 1113 in response to the illuminance being higher than or equal to the reference illuminance. For example, operation 1113 or operation 1115 may be executed based on data indicating the illuminance (or data indicating a relationship between the illuminance and the reference illuminance). For example, the data may be provided directly to the display driver circuitry 131 from an illuminance sensor of the electronic device 100. For another example, the data may be provided to the display driver circuitry 131 from the illuminance sensor through the processor 120. For another example, the display driver circuitry 131 may execute operation 1113 or execute operation 1115, based on a control signal obtained according to the relationship between the illuminance and the reference illuminance.

In operation 1113, the display driver circuitry 131 may refrain from adjusting a voltage provided to a gate electrode of at least a portion of driving transistors in the display panel 132, based on the fourth brightness level being higher than or equal to the threshold brightness level. For example, the display driver circuitry 131 may refrain from executing the operations illustrated and described with reference to FIGS. 7 and 8. For example, the display driver circuitry 131 may obtain third data changed from the second data, based on the second data. For example, the display driver circuitry 131 may execute at least a portion of the operations illustrated and described with reference to FIGS. 4 and 5. For example, the display driver circuitry 131 may obtain the third data, by processing the second data to change a brightness level of the entire area of the screen from the third brightness level to the fourth brightness level. For example, the processing of the second data may be digital processing. For example, the display driver circuitry 131 may display, on the display panel 132, the screen, based on the third data.

In operation 1115, the display driver circuitry 131 may adjust a voltage provided to a gate electrode of at least a portion of the driving transistors in the display panel 132, based on the fourth brightness level being lower than the threshold brightness level. For example, the display driver circuitry 131 may execute at least a portion of the operations illustrated and described with reference to FIGS. 7 and 8. For example, the display driver circuitry 131 may obtain fourth data changed from the second data, based on the second data. For example, the display driver circuitry 131 may execute at least a portion of the operations illustrated and described with reference to FIGS. 4 and 5. For example, the display driver circuitry 131 may obtain the fourth data, by processing the second data to change a brightness level of the entire area of the screen from the third brightness level to a fifth brightness level between the third brightness level and the fourth brightness level. For example, the display driver circuitry 131 may adjust the voltage, by providing a second voltage corresponding to the fourth brightness level to the gate electrode, instead of providing a first voltage corresponding to the fifth brightness level (or the fourth data) to the gate electrode. For example, the display driver circuitry 131 may display, on the display panel 132, the screen, based on the adjusted voltage.

As described above, the electronic device 100 may provide an enhanced eye comfort service through the operations illustrated and described with reference to FIG. 11.

Referring back to FIG. 1, as briefly described in the description of FIG. 10, the intensity at which the function is provided may vary according to a usage state of the display 130 during the day. For example, the usage state may be identified through the processor 120 and/or the display driver circuitry 131. For example, the processor 120 and/or the display driver circuitry 131 may obtain or identify information on a usage state of the display 130 and execute a function for an eye comfort based on the information. Executing the function based on the information may be illustrated and described with reference to FIG. 12.

FIG. 12 is a flowchart illustrating an example method of executing a function for an eye comfort based on information on a usage state of a display according to various embodiments.

Referring to FIG. 12, in operation 1201, the processor 120 (or the display driver circuitry 131, hereinafter referred to as the processor 120) may identify information on a usage state (or usage state during the day) of the display 130. For example, the information may be represented as color temperature, which is a parameter indicating eye fatigue. For example, the information may be obtained differently according to whether the display 130 is being used.

For example, the processor 120 may identify the information represented as color temperature through the following Equation 1, while the display 130 is not used before the event.

K=Kth−(28×N) [Equation 1]

In the Equation 1, Kth may indicate a reference color temperature (or threshold color temperature) for an eye comfort, N may indicate the number of unit time intervals included in time during which the display 130 is not used (or time during which the display 130 is disabled) before the event, and 28 kelvin (K) may indicate a color temperature capable of being changed within each of the unit time intervals. For example, 28 in the Equation 1 may be changed according to a type (or characteristic) of the display 130. As a non-limiting example, Kth may be 7000 (K).

For example, when a length of each of the unit time intervals is 10 minutes and the display 130 has not been used for 3 hours before the event, K may be 6496 (K) (7000−(28×18)). For example, the processor 120 may identify the information indicating K which is 6496.

For example, the processor 120 may identify the information while the display 130 is used before the event. For example, the display panel 132 may include first light-emitting diodes configured to emit red light, second light-emitting diodes configured to emit blue light, and third light-emitting diodes configured to emit green light. For example, the processor 120 (or the display driver circuitry 131) may identify, while the display 130 is used before the event, the information further based on a time of day during which at least a portion of the second light-emitting diodes has been emitted before the event and the number of the at least a portion of the second light-emitting diodes (or an on pixel ratio (OPR) of the second light-emitting diodes). For example, the information may be identified via the following Equation 2.

$$K = Kth - ( Kb + ( 28 \times N ) ) \qquad [ Equation 2 ]$$

In the Equation 2, Kth may indicate a reference color temperature (or threshold color temperature) for an eye comfort, N may indicate the number of unit time intervals included in time during which the display 130 is used (or time during which the display 130 is enabled for displaying a screen) before an event, 28 (K) may indicate a color temperature capable of being changed within each of the unit time intervals, and Kb may indicate a color temperature that is changed by emitting at least a portion of the second light-emitting diodes. For example, 28 of the Equation 2 may be changed according to a type (or characteristic) of the display 130. As a non-limiting example, Kth may be 7000 (K). For example, Kb may be identified via the following Equation 3.

$$Kb = \{ {( B - OPR / M )}^{⋀} G X Y \} \times L / S \times 28 \qquad [ Equation 3 ]$$

In the Equation 3, B-OPR may indicate OPR (or number) of the second light-emitting diodes that emit light for a screen displayed on the display 130 before the event, M may indicate a range of grayscale supported by the display 130, G may indicate a gamma value of the screen, Y may indicate a predetermined brightness level, L may indicate the number of times B-OPR is measured while the screen is displayed on the display 130 before the event, and S may indicate a predetermined value (e.g., a value for scaling).

For example, when a length of the unit time intervals is 10 minutes, G is 2.2, Y is 117, L is 540, S is 388, and, before the event, the display 130 has displayed a screen in which OPR of the second light-emitting diodes (e.g., B-OPR) is 130 for 90 minutes, the processor 120 may identify Kb as 1026.72 (K) (e.g., about 1008 (K)) according to Equation 3. For example, since N is 9 (=90/10) and Kb is about 1026.72 (K) (e.g., about 1008 (K)), the processor 120 may identify the information indicating K, which is about 5721.28 (K) (e.g., about 5740 (K)), according to Equation 2.

For example, the processor 120 may identify the information by applying Equation 1 to a time when the display 130 was not used before the event and applying Equations 2 and 3 to a time when the display 130 was used before the event. However, the disclosure is not limited thereto.

In operation 1203, the processor 120 may execute a function for an eye comfort, based on the identified information. For example, the processor 120 may change the intensity of the function, based on the information. The intensity of the function changed based on the information may be illustrated and described with reference to FIG. 13.

FIG. 13 is a graph illustrating an intensity of a function for an eye comport changed based on information on a usage state according to various embodiments.

Referring to FIG. 13, a graph 1300 may represent the intensity of the function identified based on the information. For example, the intensity may be at least partially different from the intensity indicated by the graph 1000.

For example, as indicated by a line 1301 of the graph 1300, the processor 120 may provide the function by gradually increasing the intensity provided at a time of day between 18 o'clock and 22 o'clock, based on the information. For example, as indicated by the line 1301 in the graph 1300, the processor 120 may provide the function by setting a speed (or velocity) of increasing the intensity at a time of day between 18 o'clock and 22 o'clock to be faster than a speed indicated by the line 1004 in the graph 1000, based on the information. However, the disclosure is not limited thereto.

For example, as indicated by a line 1302 in the graph 1300, the processor 120 may provide the function at maximum intensity at a time of day between 22 o'clock and 24 o'clock (or 0 o'clock), based on the information. For example, the processor 120 may provide, based on the information, the function, by maintaining the intensity with maximum intensity at a time of day between 22 o'clock and 24 o'clock, instead of providing the function at the intensity gradually increasing over time, as indicated by the line 1004 in the graph 1000. However, the disclosure is not limited thereto.

As described above, the electronic device 100 may provide an enhanced eye comfort service by adaptively executing a function for an eye comfort according to the usage state of the display 130.

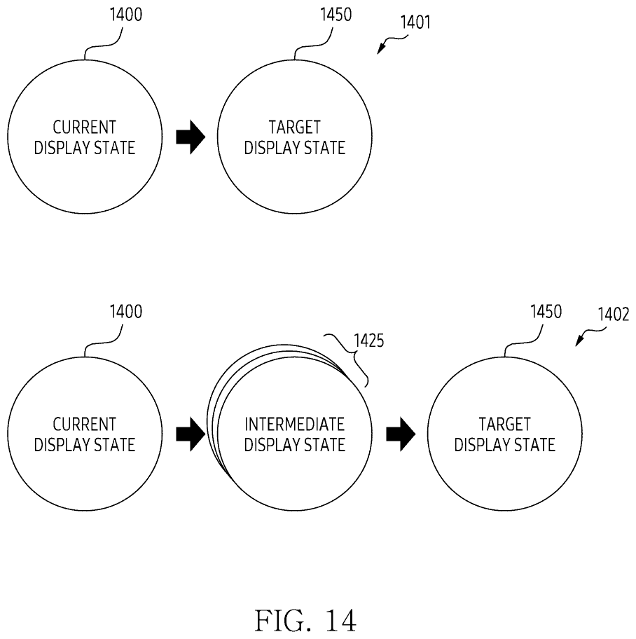

Referring back to FIG. 1, the processor 120 may provide the function by executing, based on the event, a change in a display state of the screen, including a change in a brightness level of a character within a screen displayed on the display panel 132, a change in a brightness level of an entire area of the screen, a change in a color gamut of the screen, and/or a change in color temperature of the screen. For example, when the change of the display state is executed rapidly (or sharply), the change of the display state may reduce the quality of the screen. For example, the processor 120 may control the display 130 so that a display state (e.g., current display state) of the screen is gradually changed to a display state of the screen (e.g., target display state) according to the execution of the function based on the event, for the quality of the screen. The control may be illustrated and described with reference to FIG. 14.

FIG. 14 is a diagram illustrating an example method of changing a display state through a function for an eye comfort according to various embodiments.

Referring to FIG. 14, the processor 120 may identify, based on the event, a current display state 1400 of the screen and a target display state 1450 of the screen according to the function. For example, when a difference between the current display state 1400 and the target display state 1450 is relatively small, the processor 120 may control the display 130 to directly execute a change from the current display state 1400 to the target display state 1450 based on the event, as indicated by the state 1401. For another example, when the difference between the current display state 1400 and the target display state 1450 is relatively large, the processor 120 may identify at least one intermediate display state 1425 between the current display state 1400 and the target display state 1450. For example, when the difference between the current display state 1400 and the target display state 1450 is relatively large, the processor 120 may control the display 130 to change from the current display state 1400 to the target display state 1450 via the at least one intermediate display state 1425, as indicated by the state 1402. For example, the processor 120 may gradually execute a change in a brightness level of the character, a change in a brightness level of the entire area of the screen, a change in a color gamut of the screen, and/or a change in color temperature of the screen, as indicated by the state 1402. For example, a time for changing the current display state 1400 to the target display state 1450 via the at least one intermediate display state 1425 by gradually executing a change in a brightness level of the character, a change in a brightness level of the entire area of the screen, a change in a color gamut of the screen, and/or a change in color temperature of the screen may vary in accordance with whether an illuminance around the electronic device 100 is changed. For example, the number of the at least one intermediate display state 1425 may vary according to a difference between the current display state 1400 and the target display state 1450 and/or the illuminance. However, the disclosure is not limited thereto.

As described above, the electronic device 100 may provide an enhanced eye comfort service through a gradual change in the display state of the screen.

FIG. 15 is a block diagram illustrating an example electronic device 1501 in a network environment 1500 according to various embodiments. Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In various embodiments, at least one of the components (e.g., the connecting terminal 1578) may be omitted from the electronic device 1501, or one or more other components may be added in the electronic device 1501. In various embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521. Thus, the processor 1520 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, an HDMI connector, a USB connector, a SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to an embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 1564 dB or less) for implementing mMTC, or U-plane latency (e.g., 0.5 ms or less for each of downlink (DL) and uplink (UL), or a round trip of 15 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element including a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In an embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

FIG. 16 is a block diagram 1600 illustrating an example configuration of a display module 1560 according to various embodiments. Referring to FIG. 16, the display module 1560 may include a display 1610 and a display driver integrated circuit (DDI) 1630 to control the display 1610. The DDI 1630 may include an interface module (e.g., including various circuitry and/or executable program instructions) 1631, memory 1633 (e.g., buffer memory), an image processing module (e.g., including various circuitry and/or executable program instructions) 1635, and/or a mapping module (e.g., including various circuitry and/or executable program instructions) 1637. The DDI 1630 may receive image information that contains image data or an image control signal corresponding to a command to control the image data from another component of the electronic device 1501 via the interface module 1631. For example, according to an embodiment, the image information may be received from the processor 1520 (e.g., the main processor 1521 (e.g., an application processor)) or the auxiliary processor 1523 (e.g., a graphics processing unit) operated independently from the function of the main processor 1521. The DDI 1630 may communicate, for example, with touch circuitry 1650 or the sensor module 1576 via the interface module 1631. The DDI 1630 may also store at least part of the received image information in the memory 1633, for example, on a frame by frame basis. The image processing module 1635 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1610. The mapping module 1637 may generate a voltage value or a current value corresponding to the image data pre-processed or post-processed by the image processing module 1635. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 1610 may be driven, for example, based at least in part on the voltage value or the current value such that visual information (e.g., a text, an image, or an icon) corresponding to the image data may be displayed via the display 1610.

According to an embodiment, the display module 1560 may further include the touch circuitry 1650. The touch circuitry 1650 may include a touch sensor 1651 and a touch sensor IC 1653 to control the touch sensor 1651. The touch sensor IC 1653 may control the touch sensor 1651 to sense a touch input or a hovering input with respect to a certain position on the display 1610. To achieve this, for example, the touch sensor 1651 may detect (e.g., measure) a change in a signal (e.g., a voltage, a quantity of light, a resistance, or a quantity of one or more electric charges) corresponding to the certain position on the display 1610. The touch circuitry 1650 may provide input information (e.g., a position, an area, a pressure, or a time) indicative of the touch input or the hovering input detected via the touch sensor 1651 to the processor 1520. According to an embodiment, at least part (e.g., the touch sensor IC 1653) of the touch circuitry 1650 may be formed as part of the display 1610 or the DDI 1630, or as part of another component (e.g., the auxiliary processor 1523) disposed outside the display module 1560.

According to an embodiment, the display module 1560 may further include at least one sensor (e.g., a fingerprint sensor, an iris sensor, a pressure sensor, or an illuminance sensor) of the sensor module 1576 or a control circuit for the at least one sensor. In such a case, the at least one sensor or the control circuit for the at least one sensor may be embedded in one portion of a component (e.g., the display 1610, the DDI 1630, or the touch circuitry 1650)) of the display module 1560. For example, when the sensor module 1576 embedded in the display module 1560 includes a biometric sensor (e.g., a fingerprint sensor), the biometric sensor may obtain biometric information (e.g., a fingerprint image) corresponding to a touch input received via a portion of the display 1610. As another example, when the sensor module 1576 embedded in the display module 1560 includes a pressure sensor, the pressure sensor may obtain pressure information corresponding to a touch input received via a partial or whole area of the display 1610. According to an embodiment, the touch sensor 1651 or the sensor module 1576 may be disposed between pixels in a pixel layer of the display 1610, or over or under the pixel layer.

As described above, an electronic device may comprise a processor, display driver circuitry operably coupled with the processor, and a display panel operably coupled with the display driver circuitry. According to an embodiment, the electronic device may comprise memory storing instructions to, by providing, to the display driver circuitry, first data for a screen including a character having a first brightness level, display, on the display panel, the screen. According to an embodiment, the memory may store instructions to, while the screen is displayed based on the first data, identify an event indicating to activate a function for an eye comfort. According to an embodiment, the memory may store instructions to, based on the event, display, on the display panel, the screen by providing, to the display driver circuitry, second data for the screen including the character having a second brightness level higher than the first brightness level.

According to an embodiment, the memory may store instructions to, in response to the event, identify a text object from layout data for the screen. According to an embodiment, the memory may store instructions to, based on the character included in the text object, obtain the second data partially different from the first data. According to an embodiment, the memory may store instructions to, display, on the display panel, the screen by providing, to the display driver circuitry, the second data.

According to an embodiment, the memory may store instructions to, in response to the event, identify the first brightness level. According to an embodiment, the memory may store instructions to, based on the first brightness level being lower than a reference brightness level, obtain the second data.

According to an embodiment, the memory may store instructions to, based on the first brightness level higher than or equal to the reference brightness level, refrain from obtaining the second data.

According to an embodiment, the memory may store instructions to, based on the event, obtain third data converted from the second data by processing the second data for changing a brightness level of entire area of the screen from a third brightness level to a fourth brightness level. According to an embodiment, the memory may store instructions to, display, on the display panel, the screen based on the third data.

According to an embodiment, the display panel may include light emitting diodes (LEDs), and driving transistors for respectively driving the LEDs. According to an embodiment, the memory may store instructions to cause the display driver circuitry to, based on the event, identify a fifth brightness level between the third brightness level and the fourth brightness level. According to an embodiment, the memory may store instructions to cause the display driver circuitry to obtain fourth data converted from the second data by processing the second data for changing the brightness level of the entire area of the screen from the third brightness level to the fifth brightness level. According to an embodiment, the memory may store instructions to cause the display driver circuitry to, based on providing a second voltage, corresponding to the fourth brightness level, different from a first voltage corresponding to the fifth brightness level, to a gate electrode of at least a portion of the driving transistors, display, on the display panel, the screen.

According to an embodiment, the memory may store instructions to cause the display driver circuitry to identify the fourth brightness level. According to an embodiment, the memory may store instructions to cause the display driver circuitry to, in response to the fourth brightness level lower than a threshold brightness level or a difference value, between the third brightness level and the fourth brightness level, higher than a reference value, display, on the display, the screen based on providing the second voltage to the gate electrode of at least a portion of the driving transistors. According to an embodiment, the memory may store instructions to cause the display driver circuitry to, in response to the fourth brightness level higher than or equal to the threshold brightness level or the difference value lower than or equal to the reference value, display, on the display panel, the screen based on bypassing providing the second voltage to a gate electrode of each of the driving transistors.

According to an embodiment, the memory may store instructions to cause the display driver circuitry to obtain the third data by processing the second data for further changing color gamut of the screen.

According to an embodiment, the color gamut of the screen displayed based on the third data may vary in accordance with time of day displaying the screen.

According to an embodiment, the memory may store instructions to cause the display driver circuitry to obtain the third data by processing the second data for further changing color temperature of the screen.

According to an embodiment, the color temperature of the screen displayed based on the third data may vary in accordance with time of day displaying the screen.

According to an embodiment, the LEDs may include first LEDs configured to emit red light, second LEDs configured to emit blue light, and third LEDs configured to emit green light. According to an embodiment, the memory may store instructions to cause the display driver circuitry to obtain the third data by processing the second data based on time of day in which at least a portion of the second LEDs has been emitted and a number of the at least the portion of the second LEDs, for further changing the color temperature.

According to an embodiment, the memory may store instructions to cause the display driver circuitry to, based on the event, gradually change, on the display panel, the brightness level of the entire area from the third brightness level to the fourth brightness level.

According to an embodiment, time in which the brightness level of the entire area is gradually changed from the third brightness level to the fourth brightness level may vary in accordance with whether an illuminance around the electronic device is changed.

According to an embodiment, the second brightness level may vary in accordance with time of day displaying the screen.

According to an embodiment, the character may be displayed via data represented in binary code.

As described above, a method in an electronic device including a display panel may comprise, based on first data for a screen including a character having a first brightness level, displaying, on the display panel, the screen. According to an embodiment, the method may comprise, while the screen is displayed based on the first data, identifying an event indicating to activate a function for an eye comfort. According to an embodiment, the method may comprise, based on the event, displaying, on the display panel, the screen based on second data for the screen including the character having a second brightness level higher than the first brightness level.

According to an embodiment, displaying the screen based on the second data may comprise identifying, in response to the event, a text object among the text object and an image object in layout data for the screen. According to an embodiment, displaying the screen based on the second data may comprise obtaining the second data partially different from the first data, based on the character included in the text object.

According to an embodiment, displaying the screen based on the second data may comprise identifying the first brightness level in response to the event. According to an embodiment, displaying the screen based on the second data may comprise obtaining the second data based on the first brightness level being lower than a reference brightness level.

According to an embodiment, the method may comprise refraining from obtaining the second data based on the first brightness level being higher than or equal to the reference brightness level.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
memory storing instructions;
at least one processor comprising processing circuitry;
display driver circuitry; and
a display panel,
wherein the instructions, when executed by the at least one processor individually or collectively, cause the electronic device to:
by providing, to the display driver circuitry, first data for a screen including a character having a first brightness level, display, on the display panel, the screen;
while the screen is displayed based on the first data, identify an event indicating to activate a function for an eye comfort;
based on the event, display, on the display panel, the screen by providing, to the display driver circuitry, second data for the screen including the character having a second brightness level higher than the first brightness level.

2. The electronic device of claim 1, wherein the instructions, when executed by the at least one processor individually or collectively, cause the electronic device to:
in response to the event, identify a text object from layout data for the screen;
based on the character being included in the text object, obtain the second data partially different from the first data; and
display, on the display panel, the screen by providing, to the display driver circuitry, the second data.

3. The electronic device of claim 1, wherein the instructions, when executed by the at least one processor individually or collectively, cause the electronic device to:
in response to the event, identify the first brightness level; and
based on the first brightness level being lower than a reference brightness level, obtain the second data.

4. The electronic device of claim 3, wherein the instructions, when executed by the at least one processor individually or collectively, cause the electronic device to, based on the first brightness level higher than or equal to the reference brightness level, refrain from obtaining the second data.

5. The electronic device of claim 1, wherein the display driver circuitry is further configured to:
based on the event, obtain third data converted from the second data by processing the second data for changing a brightness level of entire area of the screen from a third brightness level to a fourth brightness level; and
display, on the display panel, the screen based on the third data.

6. The electronic device of claim 5, wherein the display panel includes light emitting diodes (LEDs), and driving transistors configured to respectively drive the LEDs, and
wherein the display driver circuitry is further configured to:
based on the event, identify a fifth brightness level between the third brightness level and the fourth brightness level;
obtain fourth data converted from the second data by processing the second data for changing the brightness level of the entire area of the screen from the third brightness level to the fifth brightness level; and
based on providing a second voltage, corresponding to the fourth brightness level, different from a first voltage corresponding to the fifth brightness level, to a gate electrode of at least a portion of the driving transistors, display, on the display panel, the screen.

7. The electronic device of claim 6, wherein the display driver circuitry is further configured to:
identify the fourth brightness level;
in response to the fourth brightness level being lower than a threshold brightness level or a difference value, between the third brightness level and the fourth brightness level, being higher than a reference value, display, on the display, the screen based on providing the second voltage to the gate electrode of at least a portion of the driving transistors; and
in response to the fourth brightness level being higher than or equal to the threshold brightness level or the difference value lower being than or equal to the reference value, display, on the display panel, the screen based on bypassing providing the second voltage to a gate electrode of each of the driving transistors.

8. The electronic device of claim 5, wherein the display driver circuitry is configured to obtain the third data by processing the second data for further changing color gamut of the screen.

9. The electronic device of claim 8, wherein the color gamut of the screen displayed based on the third data is configured to vary in accordance with time of day displaying the screen.

10. The electronic device of claim 5, wherein the display driver circuitry is configured to obtain the third data by processing the second data for further changing color temperature of the screen.

11. The electronic device of claim 10, wherein the color temperature of the screen displayed based on the third data is configured to vary in accordance with time of day displaying the screen.

12. The electronic device of claim 10, wherein the LEDs includes:
first LEDs configured to emit red light;
second LEDs configured to emit blue light; and
third LEDs configured to emit green light, and
wherein the display driver circuitry is configured to obtain the third data by processing the second data based on time of day in which at least a portion of the second LEDs has been emitted and a number of the at least the portion of the second LEDs, for further changing the color temperature.

13. The electronic device of claim 5, wherein the display driver circuitry is further configured to, based on the event, gradually change, on the display panel, the brightness level of the entire area from the third brightness level to the fourth brightness level.

14. The electronic device of claim 13, wherein a time in which the brightness level of the entire area is gradually changed from the third brightness level to the fourth brightness level is configured to vary in accordance with whether an illuminance around the electronic device is changed.

15. The electronic device of claim 1, wherein the second brightness level is configured to vary in accordance with time of day displaying the screen.

16. The electronic device of claim 1, wherein the character is displayed via data represented in binary code.

17. A method of operating an electronic device including a display panel, the method comprising:
based on first data for a screen including a character having a first brightness level, displaying, on the display panel, the screen;
while the screen is displayed based on the first data, identifying an event indicating to activate a function for an eye comfort;
based on the event, displaying, on the display panel, the screen based on second data for the screen including the character having a second brightness level higher than the first brightness level.

18. The method of claim 17, wherein displaying the screen based on the second data comprises:
identifying, in response to the event, a text object among the text object and an image object in layout data for the screen;
obtaining the second data partially different from the first data, based on the character included in the text object; and
displaying the screen on the display panel by providing the second data to the display driver circuitry.

19. The method of claim 17, wherein displaying the screen based on the second data comprises identifying the first brightness level in response to the event, and
displaying the screen based on the second data comprises:
obtaining the second data based on the first brightness level being lower than a reference brightness level; and
displaying the screen based on the second data.

20. The method of claim 19, further comprising:
refraining from obtaining the second data based on the first brightness level being higher than or equal to the reference brightness level.
